(19) United States
(12) Patent Application Publication
(10) Pub. No.: US 2017/0309163 A1
(43) Pub. Date: Oct. 26, 2017

(54) CONTROL METHOD AND SYSTEM FOR WIRELESS REMOTE CONTROL

(71) Applicant: Ning LIAN, Beijing (CN)

(72) Inventor: Ning LIAN, Beijing (CN)

(21) Appl. No.: 15/517,169

(22) PCT Filed: Mar. 3, 2015
(86) PCT No.: PCT/CN2015/073529

§ 371 Date: Apr. 6, 2017

(30) Foreign Application Priority Data
Jan. 6, 2015 (CN) 201510005761.0

(51) Int. Cl. G08C 17/02; H04W 12/06

(52) U.S. Cl. CPC G08C 17/02; H04W 12/06; G08C 2201/93

(57) ABSTRACT

A control method and system for a wireless remote control. The control method comprises: a wireless remote control end establishing a connection with a remotely controlled end through a control centre, and selecting the remotely controlled end to be remotely controlled as a current remotely controlled end (100); the control centre receiving destination operation behaviour data from the wireless remote control end and parsing same (200); judging whether information about the parsed data matches a control instruction comparison table preset by the control centre (300); if so, judging whether a control instruction receiving end is the current remotely controlled end (400); and if so, issuing a corresponding control instruction to the current remotely controlled end (500); otherwise, establishing a connection with an end to be remotely controlled, thereby improving the control convenience of the wireless remote control.

### BACKGROUND OF THE INVENTION

The present application claims the priority of the invention titled A Control Method and System for a Wireless Remote Control, Application No.: 2015100057610, and filed on Jan. 6, 2015, all of which are incorporated by reference.

The present application relates to the field of computer applications technology, in particular to a control method and system for a wireless remote control.

With technological development and the improvement of living standards, there are a growing number of modern, smart appliances in our daily life and work. As a device for controlling appliances remotely, a remote control eases the control of the appliances. Currently, there are the following methods for remotely controlling smart appliances or furniture and other devices:

1. Pressing keys on a physical remote control to control a control device.

The number of physical keys on a physical remote control is limited by the size of the physical remote control. Therefore, this control method cannot realize one-to-many control as one remote control typically corresponds to one control device.

2. Using smart phone software to simulate keys of a physical remote control, which allows a user to control a control device by clicking on button icons displayed on a smart-phone screen.

In this control method, a smart phone is used to control a control device. Nevertheless, current remotely controllable appliances typically adopt infrared remote control signals while smart phones typically support Bluetooth signal transmission technology. The method currently applies only to appliances with Bluetooth capability, so this control method is not available for wide applications.

3. Control method of a smart device

A smart control device using this control method does not have any physical keys. In this control method, a smart control device is placed in close proximity to a device to be controlled and NFC or Bluetooth signals are used for signal transmission to unlock a lock that supports NFC signals or Bluetooth signals. Only a very limited scope of devices is controllable with this method, and the method has low security.

How to provide a control method and system for a wireless remote control that realize control over a plurality of different remotely controlled ends through a single remote control end has become a technical problem that those skilled in the art need to solve.

### BRIEF SUMMARY OF THE INVENTION

The present application provides a control method and system for a wireless remote control to solve the aforesaid technical problems.

The application provides a control method for a wireless remote control, comprising: a wireless remote control end establishing a connection with a remotely controlled end through a control centre, and selecting the remotely controlled end to be remotely controlled as a current remotely controlled end; the control centre receiving target operation behaviour data from the wireless remote control end and parsing the same; judging whether information about the parsed data matches a control instruction comparison table preset by the control centre; if so, judging whether a control instruction receiving end is the current remotely controlled end; and if so, issuing a corresponding control instruction to the current remotely controlled end; otherwise, establishing a connection with an end to be remotely controlled, wherein, the control instruction receiving end is the remotely controlled end corresponding to the target operation behaviour data in the control instruction comparison table and the end to be remotely controlled is the control instruction receiving end.

alternatively, establishing a connection between a wireless remote control end and a remotely controlled end through a control centre, comprising: assigning a unique identification code to the wireless remote control end; the wireless remote control end sending connection operation behavior data and the identification code to the control centre; the control centre judging whether the identification code matches an identification code pre-stored in the control centre; if so, parsing the connection operation behaviour data; judging whether information about the parsed data matches a preset control instruction comparison table; and if so, selecting the remotely controlled end corresponding to the connection operation behaviour data as the current remotely controlled end.

alternatively, before selecting the remotely controlled end corresponding to the connection operation behaviour data as the current remotely controlled end, comprising: the control centre sending security authentication request information to the wireless remote control end; the wireless remote control end obtaining authentication operation behaviour data based on the authentication request information and sending the same to the control centre; the control centre parsing the authentication operation behaviour data; judging whether information about the parsed data matches a preset control instruction comparison table; and if so, proceeding to the step of issuing a corresponding control instruction to the current remotely controlled end.

alternatively, the preset control instruction comparison table comprising: building a control instruction comparison table of a one-to-one match between the connection operation behaviour data and the remotely controlled end; a control instruction comparison table of a one-to-one match between the target operation behaviour data and the remotely controlled end; and a control instruction comparison table of a one-to-one match between the authentication operation behaviour data and the remotely controlled end.

alternatively, the connection operation behaviour data, target operation behaviour data and authentication operation behaviour data are touch operation behaviour data applied to the wireless remote control end or gesture operation behaviour data applied to the wireless remote control end respectively.

alternatively, judging whether information about the parsed data matches a control instruction comparison table preset by the control centre, comprising: selecting single feature data or a plurality of feature data in the data information as a comparison criterion; judging whether the comparison criterion falls into the threshold scope set in the control instruction comparison table; and if so, indicating a successful match, proceeding to the next step.

alternatively, feature data of the data information comprising spatial track data, speed, acceleration, time, distance between a starting point and an end point and/or angle of an operation behavior.

alternatively, the wireless remote control end encrypting the target operation behaviour data, connection operation behaviour data, and/or authentication operation behaviour data and sending the same to the control centre.

alternatively, after the step of judging whether information about the parsed data matches a control instruction comparison table preset by the control centre, comprising: the control centre feeding back prompt information in the form of vibration, sound, or light to the wireless remote control end.

The application further provides a control system for a wireless remote control, comprising: a wireless remote control end used to obtain operation behaviour data, establish a connection with a remotely controlled end through a control processing device, and select the remotely controlled end to be remotely controlled; a control processing device receiving operation behaviour data from the wireless remote control end, parsing the same, and judging whether information about the parsed data matches a control instruction comparison table preset by the control processing device; if so, judging whether a control instruction receiving end is the current remotely controlled end; if so, issuing a corresponding control instruction to the current remotely controlled end; otherwise, establishing a connection with an end to be remotely controlled; and a remotely controlled end receiving the control instruction and performing a corresponding operation based on the control instruction.

The application provides a control method for a wireless remote control. A connection is established between a wireless remote control end and a remotely controlled end through a control centre. A current remotely controlled end is determined. Then a corresponding target operation behavior is obtained through the wireless remote control end and the same is sent to the control centre. If determining that the target operation behavior is a corresponding control instruction that controls the current remotely controlled end, the control centre sends the control instruction to the remotely controlled end to achieve corresponding control. If the target operation behavior is used to control an end to be remotely controlled, the wireless remote control end establishes a connection with the end to be remotely controlled through the control centre, thereby realizing control over other ends to be remotely controlled. In this way, a same wireless remote control end can control a variety of ends to be remotely controlled, making remote control easier.

### BRIEF DESCRIPTION OF THE DRAWINGS

In order to more clearly describe technical solutions in embodiments of the utility model and the prior art, the following will briefly describe drawings required in descriptions of embodiments and the prior art. Obviously, the following drawings are only several embodiments of the utility model. Persons of ordinary skill in the art may also obtain other drawings according to these accompanying drawings without creative efforts.

FIG. 1 is a flowchart diagram of Embodiment 1 of a control method for a wireless remote control provided by the present application;

FIG. 2 is a flowchart diagram of the embodiment of Step 100 in a control method for a wireless remote control provided by the present application;

FIG. 3 is a structure diagram of Embodiment 1 of a control system for a wireless remote control provided by the present application.

### DETAILED DESCRIPTION OF THE INVENTION

For better understanding of the present application, many specific details are explained in the following description. The present application, however, can be implemented in ways different from the ones described herein. Those skilled in the art may make similar deductions without departing from the content of the application. Therefore, the present application is not limited by the specific embodiments disclosed below.

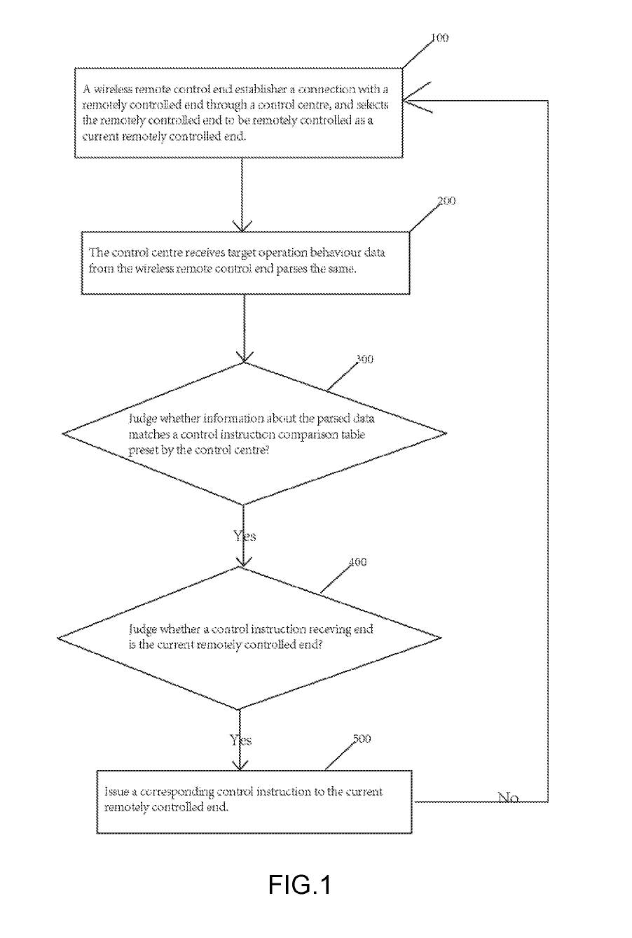

Referring to FIG. 1, FIG. 1 is a flowchart diagram of Embodiment 1 of a control method for a wireless remote control provided by the present application. The control method can achieve the control over a single remotely controlled end and a plurality of different remotely controlled ends. For better understanding of the control method of the present application, the following description is provided with a wearable touchscreen device, for example, a watch, as a remote control end and a device such as an entrance door, TV, air conditioner as a remotely controlled end. Details are as follows:

Step 100: A wireless remote control end establishes a connection with a remotely controlled end through a control centre, and selects the remotely controlled end to be remotely controlled as a current remotely controlled end.

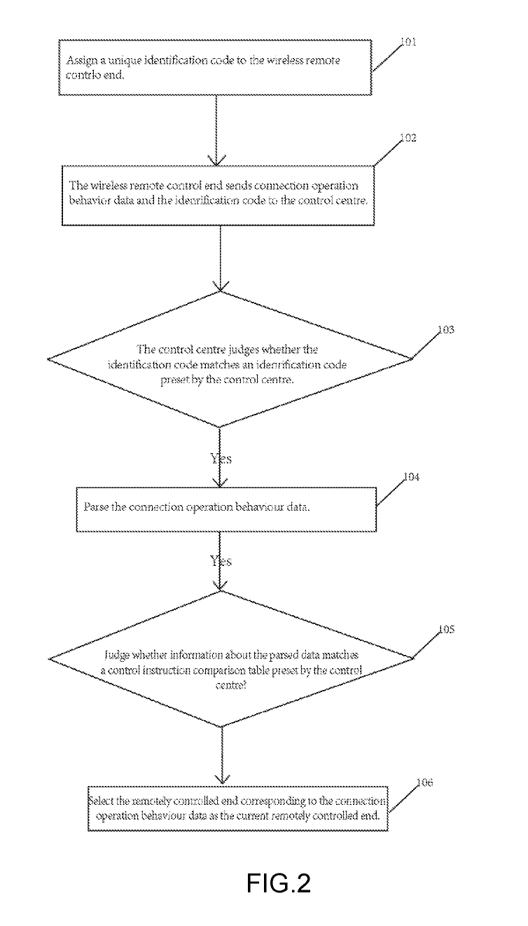

In combination with FIG. 1 and with reference to FIG. 2, FIG. 2 is a flow diagram of the specific implementation process of the Step 100. The Step 100 may comprise the following steps:

Step 101: Assign a unique identification code to the wireless remote control watch;

The identification code in the step can be used as identification information, which is pre-stored in the control centre with corresponding wireless remote control watch information.

Step 102: The wireless remote control end sends connection operation behaviour data and the identification code to the control centre;

The specific implementation process of the step can be that the wireless remote control watch obtains data about a connection operation behaviour. For example, upon the receipt of data about a user's action of sweeping an arc 180 degrees clockwise on the touch dial of the wireless remote control watch, a connection between the wireless remote control watch and a remotely controlled end TV is considered to be established. A control instruction corresponding to the action can be a control instruction for turning on the TV, and it can be understood that the control instruction for turning on the TV may also correspond to other actions, for example, a user's swiping from left to right on the dial horizontally over a distance of 5 to 10 cm.

It should be noted that a control instruction comparison table where operation behaviour, control instructions, and remotely controlled ends match each other is preset in the control centre. Specifically, the control instruction comparison table is about a one-to-one match between the connection operation behaviour data, the control instruction, and the remotely controlled end. In the embodiment, a control instruction comparison table can be set with methods in Table 1 and Table 2 and the methods in Table 1 and Table 2 can be set in one such table.

TABLE 1

| | Control | Remotely |
|---|---|---|
| Connection Operation Behavior | Instruction | Controlled End |
| Sweep an arc 90 degrees clockwise | Turn on | Entrance door |
| Sweep an arc 180 degrees clockwise | Turn on | TV |
| Sweep an arc 270 degrees clockwise | Turn on | Air conditioner |

TABLE 2

| | | Remotely |
|---|---|---|
| | | Controlled |
| Target Operation Behavior | Control Instruction | End |
| Spatial motion from left to right | Switch to the next | TV |
| | channel | |
| Spatial motion from right to left | Return to the previous | TV |
| | channel | |
| Spatial motion of drawing a circle | Add to Favorites | TV |
| Spatial motion from left to right | Raise the temperature | Air |
| | | conditioner |
| Spatial motion from right to left | Lower the temperature | Air |
| | | conditioner |
| Spatial motion of drawing a circle | Switch modes | Air |
| | | conditioner |

The process of presetting a control instruction comparison table in a control centre may adopt the following methods:

presetting default operation behaviors including touch and/or air gesture operations in a control centre; furthermore, storing, in a control centre, remote control instructions of a large number of remotely controllable devices (such as TVs, air conditioners, lighting and smart homes), for example, remote control instructions of air conditioners of a certain model. A control centre may also have networking capability to update a control instruction comparison table and device models through a remote server and extend the control instruction comparison table to control more remotely controlled devices.

For example, when a user turns on a control centre and selects the model of an air conditioner to be remotely controlled, the control centre displays on the screen control instructions of the air conditioner, for example, powering on the air conditioner and raising or reducing the temperature. These control instructions refer to control functions corresponding to things such as keys on a remote control of an air conditioner. A user may associate a default motion with a corresponding control function via a control centre. For instance, touch operations are used to associate a left to right motion with the function of raising the temperature of an air conditioner. In addition, a user may also customize gestures. For example, a user goes to the settings screen, clicks gesture settings, selects the left or right hand, and moves on the side of the hand with a wireless remote control watch. The control centre will display the motion just made on the screen. After confirmation, the user repeats the same motion. The control centre will select appropriate data information from the repeated motions for recording. Error threshold scopes allowed by relevant motions can also be set based on the recorded data information. The control centre saves the data information that will then be included in a control instruction comparison table. In applications with higher security requirements, a user may reduce threshold scopes, which means that the user needs to precisely repeat a motion to make an operation available.

After obtaining connection operation behaviour data of sweeping an arc 180 degrees clockwise, the wireless remote control watch sends the data with the identification code to the control centre.

Step 103: The control centre judges whether the identification code matches an identification code pre-stored in the control centre. If so, proceed to Step 104 of parsing connection operation behaviour data;

The specific implementation process of the Step 103 can be the following: The control centre first judges whether the identification code matches an identification code of an authorizable wireless remote control watch preset in the control centre. If so, the control centre parses connection operation behaviour data of sweeping an arc 180 degrees clockwise and obtains data information related to the connection operation behaviour data. The data information may include the slide angle, speed, acceleration and/or distance between a starting point and an end point of operation behaviour, and other feature data information that represents the connection operation behaviour data.

Step 105: Judge whether information about the parsed data matches a preset control instruction comparison table. If so, proceed to Step 106 of selecting the remotely controlled end corresponding to the connection operation behaviour data as the current remotely controlled end:

The specific implementation process of the Step 105 can be the following: The control centre selects certain feature data information of information about the parsed data and compares the feature data information with the control instruction comparison table preset in the control centre. If the feature data information falls into a threshold scope set in the control instruction comparison table for data information of an operation behavior related to the control instruction of turning on a TV, the control centre selects the TV as the current remotely controlled end and sends the control instruction to the TV. The TV is turned on, thus achieving a communication connection between the wireless remote control watch and the current remotely controlled end TV. The threshold scope can be an allowable error range of the operation behaviour data.

To improve security, the control centre can send security authentication request information to the wireless remote control watch that a user wears if it identifies a match. After receiving the security authentication request information, the wireless remote control watch obtains authentication operation behaviour data based on preset operation behaviour. The authentication operation behavior can be drawing a check mark (“√”) in the air with the arm where the wireless remote control watch is worn or repeating the previous connection operation behaviour. Certainly, the behavior can also be drawing a check mark on the dial of the wireless remote control watch. The control centre receives the authentication operation behaviour data and parses the same to obtain relevant feature data information of the authentication operation behaviour data. The control centre compares the information with data information in the control instruction comparison table. If the feature data falls into a preset threshold scope, the authentication passes. In this case, the control centre sends the control instruction of turning on the TV to the TV and the TV is turned on. If the feature data information of the authentication operation behaviour data does not fall into a preset threshold scope, the control centre may feedback prompt information to the user's wireless remote control watch. The prompt information may be in the form of vibration, sound or light to notify the user of incorrect operation behaviour data input.

It should be noted that in the control instruction comparison table, a one-to-one match between the authentication operation behavior data and a security instruction of the remotely controlled end is established, for example, a security match between the operation behaviour data of drawing a check mark and the control instruction of turning on a TV.

Step 200: The control centre receives target operation behaviour data from the wireless remote control end and parses the same;

The specific implementation process of the step can be the following: After Step 100 of establishing a connection between a wireless remote control watch and a remotely controlled end, the wireless remote control watch obtains a user's target operation behaviour data. The target operation behaviour data can be swinging an arm where the user wears the wireless remote control watch from left to right once. The target operation behaviour data indicates switching the TV to the next channel in the control instruction comparison table. In other word, the control instruction is “switching to the next channel”. It can be understood that this control instruction can also be achieved by the presetting of an operation behavior as a touch and slide operation on the dial.

After receiving the operation behaviour of “switching to the next channel”, the control centre parses the operation behaviour to obtain feature data information of data about the operation behaviour. The feature data information can be the distance between a starting point and an end point, spatial track, speed and/or acceleration, etc.

It should be noted that the target operation behaviour data is parsed in Step 200 in the same way as the connection operation behaviour data is parsed in the Step 103 and the information about the parsed data is information related to feature data of the target operation behaviour data. Similarly, the authentication operation behaviour data is also parsed in the same way, and the information about the parsed data is information related to feature data of the authentication operation behaviour data.

Step 300: Judge whether information about the parsed data matches a control instruction comparison table preset by the control centre. If so, proceed to Step 400.

The specific implementation process of the step is that a control instruction comparison table is preset in the control centre, which can be known from the Step 100. Control instructions of all remotely controllable ends and corresponding operation behaviour data are set in the control instruction comparison table. After receiving operation behaviour data of swinging from left to right sent by the wireless remote control watch, the control centre parses the operation behaviour data and uses certain feature data (for example, distance feature data obtained after the parsing of operation behaviour data of swinging from left to right once) in information about the parsed data as a comparison criterion to compare with the control instruction comparison table. If the comparison criterion falls into a threshold scope set in the control instruction comparison table, the match is successful.

Excessive operation behaviour may result in complexity in control over remotely controlled ends through operation behaviour. Therefore, same target operation behaviour data can be used to control different remotely controlled ends in the present application. For example, in above-described Table 1 and Table 2, a TV can be switched to the next channel by the gesture of swinging an arm from left to right or the touch of sliding the dial from left to right while the temperature of an air conditioner can also be raised in the two ways.

In the circumstance where “the match is successful” as described above, same target operation behaviour data may correspond to two or more remotely controlled ends. To ensure the accuracy of control, further judgment is required after a successful match. In other word, the process goes to Step 400.

Step 400: Judge whether a control instruction receiving end is the current remotely controlled end. If so, proceed to Step 500; otherwise, proceed to Step 100.

Specifically, the Step 400 is to judge whether a remotely controlled end corresponding to the target operation behaviour data in a control instruction comparison table is the current remotely controlled end, namely, the TV. If so, the process goes to Step 500 of issuing to the TV the control instruction of switching to the next channel. The control over the TV is adjusted immediately. If not, the target operation behaviour data of swinging an arm from left to right corresponds to an end to be remotely controlled, for example, an air conditioner. In this case, the process returns to Step 100 to establish a communication connection between the wireless remote control watch and the air conditioner.

To improve the accuracy and security of control, feature data (such as speed, acceleration, and distance) of the operation behaviour data of swinging from left to right once can also be used as a combined criterion for comparison with a control instruction comparison table. If the feature data falls into respective preset threshold scopes, the match is successful.

It should be noted that the above-mentioned comparison with a control instruction comparison table by using single feature data or a plurality of feature data as the comparison criterion is not limited to the operation behaviour data, but also applicable for the connection operation behaviour data and the authentication operation behaviour data, which can further improve the accuracy and security of control.

A plurality of feature data can be used in a remotely controlled end with higher security level (e.g. the opening of a vehicle door or an entrance door) as the comparison criterion, or used in combination with the above-mentioned authentication operation behaviour data.

All the operation behaviour data and identification code obtained by the wireless remote control watch can be encrypted before being sent to the control centre for decryption and subsequent operations.

When controlling the remotely controlled end through the control centre, the wireless remote control end can, via different settings of the control instruction comparison table of the control centre, achieve the control of a plurality of different remotely controlled ends or a single remotely controlled end, or the activation of security authentication based on the required security level. These settings can be realized in form of defaults, for example, when a single remotely controlled end is to be controlled, only the control instruction comparison table corresponding to this remotely controlled end will be activated, when a plurality of remotely controlled ends are to be controlled, all the control instruction comparison tables will be activated; and when the security level is relatively low, the authentication operation behaviour data in the control instruction comparison table will be in a dormant state, otherwise, such authentication operation behaviour data will be in a working state.

When the control centre is required to be connected with a new remotely controlled end, it's feasible to update the control instruction comparison table based on the control requirements of the new remotely controlled end, or update the control instructions of the current remotely controlled end, for example, to increase or decrease the control instructions.

In Step 101, the unique identification code assigned to the wireless remote control watch is pre-stored in the control centre and has a one-to-one match with the wireless remote control watch. The control centre can determine the control authority corresponding to the remotely controlled end via the setting of identification code, for example, the access authority to a television channel. That is, if the preset identification code has no access authority to some television channels, the control instruction of switching to the next channel corresponding to the operation behaviour data of swinging from left to right once will only proceed to the authorized television channels one by one and skip these unauthorized. It can be understood that the control centre can also determine the startup authority corresponding to the remotely controlled end, for example, the remotely controlled devices which are potentially unsafe for children will be set unable to be started up by children.

It's to be noted that, for the same remotely controlled end, there is a one-to-one match between the control instruction and the target operation behaviour data; and for different remotely controlled ends, the target operation behaviour data can be repeatable, i.e., the same target operation behaviour data may correspond to different remotely controlled ends. However, the connection operation behaviour data for establishing the connection between the wireless remote control end and the remotely controlled end shall have a one-to-one match with the control instruction, and no repetition is allowed. For example, sweeping an arc 180 degrees clockwise is to turn on the TV, and sweeping an arc 270 degrees clockwise is to turn on the air conditioner. While, the operation behaviour of sliding from left to right can control the TV to switch to the next channel, or raise the temperature of the air conditioner; and the operation behaviour of sliding from right to left can control the TV to return to the previous channel, or lower the temperature of the air conditioner.

In the present application, the operation behaviour data such as the target operation behaviour data, connection operation behaviour data and authentication operation behaviour data can be set as the touch operation behaviour data applied to the wireless remote control end or the gesture operation behaviour data applied to the wireless remote control end. In the above-mentioned embodiment, the operation behavior to connect the remotely controlled end is to touch the dial, and the further target operations of the current remotely controlled end are realized by gesture operation behaviour. It can be understood that all the operation behaviour can be limited to touch operation behaviour or gesture operation behaviour, which can also be combined in use to simplify the control processes and control instructions.

The data transmission between the above-mentioned wireless remote control end and the control centre can be realized by wireless network or Bluetooth, and that between the control centre and the remotely controlled end can be realized by infrared technology or Bluetooth (if the remotely controlled end has Bluetooth function).

The foregoing is a detailed description of a control method for a wireless remote control provided herein, and to facilitate an understanding of the present application, the application scenarios of the control process of the present application will be elaborated below:

Scenario 1: A user wearing a wireless remote control watch goes to the door and sweeps an arc 90 degrees clockwise on the dial of the wireless remote control watch. The wireless remote control watch sends a communication request, together with its ID, to the indoor control centre via Bluetooth technology. The data information will be encrypted before being sent out.

After receiving the operation behaviour data of sweeping an arc 90 degrees clockwise and the ID from the wireless remote control watch, the indoor control centre decrypts the data information, then determines whether the wireless remote control watch is authorized by making comparison with the ID. If so, the connection between the wireless remote control watch and the remotely controlled end will be established through the control centre.

The control centre, upon receipt of the operation behaviour data of sweeping an arc 90 degrees clockwise, will compare such data with the preset internal control instruction comparison table, and discovers that the instruction corresponding to sweeping an arc 90 degrees clockwise is to open the door.

The control centre instructs the wireless remote control watch for further security authentication.

The wireless remote control watch sends a request for further security authentication to the user waiting outside by light or vibration before the door is opened.

The user makes an authentication gesture by waving the arm wearing the wireless remote control watch in accordance with the preset security authentication gesture, such as the preset gesture of drawing an “L” in the air. The wireless remote control watch then collects data about the gesture movement, such as consecutive coordinate points in an X-Y-Z axis coordinate system and/or acceleration values, and sends such data to the control centre using encrypted signal.

The control centre parses the data received and compares the parsed data with the control instruction comparison table. If the security gesture is the same with the preset one, the control centre opens the door controlled by the electric-magnetic lock. Then, the user comes in and closes the door.

Scenario 2: A user makes connection operation behaviour by sweeping an arc 180 degrees clockwise on the dial of a wireless remote control watch. Then, the target operation behaviour data, together with the ID of the wireless remote control watch, are sent to the control centre via Bluetooth. The data may be encrypted before being sent out.

After receiving the data from the wireless remote control watch, the control centre decrypts the data information, and determines via the ID whether the wireless remote control watch is authorized. If so, the connection between the wireless remote control watch and the remotely controlled end is established. Based on the control instruction comparison table, the control instruction corresponding to sweeping an arc 180 degrees clockwise is to turn the TV. Then, the control centre demands the smart TV to turn on via infrared signal and control instruction. As the security level to turn on a TV is relatively low, it may not be necessary to conduct security authentication, while the user may perform the setting based on individual demands.

When the smart TV is turned on, or the comparison between sweeping an arc 180 degrees clockwise and the control instruction comparison table is done, the wireless remote control watch will feed back prompt information to the wireless remote control end in form of light, vibration or sound through the control centre to instruct the user that the previous instruction is completed (prompt information can still be fed back when the comparison indicates a failed match).

The user can wave the arm wearing the wireless remote control watch from left to right in the air, and the wireless remote control watch will encrypt the feature data relating to this gesture, such as consecutive coordinate points in an X-Y-Z axis coordinate system and/or acceleration values, and send it to the control centre.

The control centre will decrypt and parse the gesture of waving the arm from left to right in the air, and determine, with reference to the control instruction comparison and/or security authentication table, whether this gesture matches the control instruction of switching to the next channel in the control instruction comparison table, if so, the control centre will send an instruction to the smart TV to switch to the next channel. In addition, if this gesture matches the control instruction of raising the temperature of the air conditioner in the control instruction comparison table, the wireless remote control watch will establish a connection with the air conditioner and turns it on.

Scenario 3:

1. A user sits on a sofa with a personal control instruction input terminal.

2. The user raises a wrist and sweeps an arc 90 degrees clockwise with a finger on the dial of the personal control instruction input terminal.

3. The personal control instruction input terminal displays the TV symbol. If the user does not want to select the TV, he may continue to sweep a greater angle.

If the user wants to select the TV, he may stop sweeping. The following gives an example of control over TVs.

4. If there are two TVs in a room, the user's finger needs to stay at the ending point (at 90 degrees) for a while to switch between the two TVs after the TV symbol lights up on the personal control instruction input terminal.

5. The indoor smart home control centre selects to turn on the desired TV and waits for further instructions after determining that pre-authorization has been granted to the personal control instruction terminal it is communicating with.

6. After startup, the user's TV controlled by a set-top box (STB) displays “VOD”, “Playback”, and “Live” menus and asks the user to select one.

7. The user waves his arm parallelly to the right in accordance with the system default action. The control centre considers the action as making a single forward selection and sends related STB instructions to the STB.

8. The user stops the cursor on the “Live” menu by waving his arm parallelly.

9. The user bends his arm and stretches it forward. The control centre considers this action as confirmation and sends STB instructions to the STB. The TV then displays TV channels for selection.

10. The user waves his arm to the right just like flipping a page in accordance with the system default action. The control centre considers the action as fast forwarding, for example, turning a page listing five channels every time.

11. The user continues to wave his arm parallelly to the right to change channels one by one until he sees his desired channel.

12. The user bends his arm and stretches it forward. This action is considered as confirmation and the TV plays a program on the channel desired by the user.

13. To turn off the TV, the user needs to sweep 90 degrees counterclockwise on the dial of the personal control instruction input terminal.

It should also be noted that the method or system protected in the present application may adopt different gesture identification levels and dynamic security levels for different application scenarios.

For example, in a bank, a clerk must strictly follow preset actions (for example, errors of action data such as X, Y, and Z coordinates and acceleration should be within certain thresholds) to open a bank vault door. In contrast, system precision requirements are lower in household applications, for example, when a user watches TV at home. For instance, as long as the user waves his arm to the left or right roughly like flipping a page even in a way different from the required action of waving an arm parallelly to the left or right, the system still considers this action as fast forwarding or rewinding by five channels rather than moving forward or back by one channel.

The foregoing is the application scenarios in indoor remotely controlled electric equipment or smart home appliance of a control method for a wireless remote control of the present application. The control method for a wireless remote control provided herein can also be used in stage performance. For example, when a dancer waves his arms at the time of making various gestures, the stage background or special effect will be changed accordingly, such as: to let off fireworks.

The control centre will monitor the arm's consecutive movement within a period in advance, and attach specific control instructions to different movement paths (being the same with background music), which are used to control the stage background or special effect. After the settings have been completed, when the arm of the dancer makes a certain movement, the control centre will send a specific instruction to the remotely controlled stage background control device to change the stage background, etc.

The foregoing is a detailed description of a control method for a wireless remote control provided herein, and based on this control method, the present application provides a control system for a wireless remote control, which will be elaborated below:

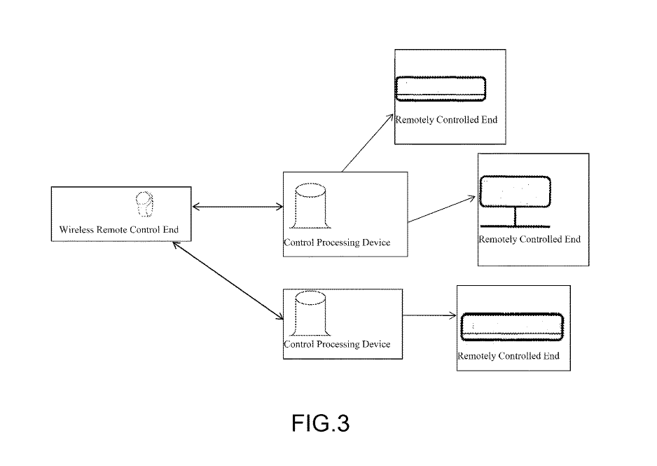

Referring to FIG. 3, FIG. 3 is a structure diagram of Embodiment 1 of a control system for a wireless remote control provided by the present application; the system comprises:

a wireless remote control end used to obtain operation behaviour data, establish a connection with a remotely controlled end through a control processing device, and select the remotely controlled end to be remotely controlled;

a control processing device receiving operation behaviour data from the wireless remote control end, parsing the same, and judging whether information about the parsed data matches a control instruction comparison table preset by the control processing device; if so, judging whether a control instruction receiving end is the current remotely controlled end; and if so, issuing a corresponding control instruction to the current remotely controlled end; otherwise, establishing a connection with the end to be remotely controlled;

a remotely controlled end receiving the control instruction and performing a corresponding operation based on the control instruction.

The system is only schematically described. The method can be referred to for specific content of the system, which is therefore not further elaborated herein.

The control method for a wireless remote control provided herein can realize the controlling of one or more remotely controlled devices through a wireless remote control end, and boasts convenient operation and high security.

It should be noted that the above-mentioned wearable wireless remote control end is only described in form of watch, but it's not limited to this. Further, all the operation behaviour data involved herein is not limited to the operation behaviour mentioned above which are illustrated as examples.

A control method and system for a wireless remote control of the present application is described above. Although the application has been disclosed as above in the preferred embodiment, it's not intended to limit the application. It will be apparent to those skilled in the art that various modifications and variations can be made to the present application without departing from the scope or spirit of the application. Therefore, the protection scope of the present application should be subject to the protection scope of the claims.

What is claimed is:

1. A control method for a wireless remote control, characterized by:
a wireless remote control end establishing a connection with a remotely controlled end through a control centre, and selecting the remotely controlled end to be remotely controlled as a current remotely controlled end;
the control centre receiving target operation behaviour data from the wireless remote control end and parsing the same;
judging whether information about the parsed data matches a control instruction comparison table preset by the control centre; if so, judging whether a control instruction receiving end is the current remotely controlled end; and if so, issuing a corresponding control instruction to the current remotely controlled end; otherwise, establishing a connection with an end to be remotely controlled.

2. The control method for a wireless remote control of claim 1, characterized by establishing a connection between a wireless remote control end and a remotely controlled end through a control centre, comprising:
assigning a unique identification code to the wireless remote control end;
the wireless remote control end sending connection operation behavior data and the identification code to the control centre;
the control centre judging whether the identification code matches an identification code preset by the control centre; if so, parsing the connection operation behaviour data;
judging whether information about the parsed data matches a control instruction comparison table preset by the control centre; and if so, selecting the remotely controlled end corresponding to the connection operation behaviour data as the current remotely controlled end.

3. The control method for a wireless remote control of claim 2, characterized by before selecting the remotely controlled end corresponding to the connection operation behaviour data as the current remotely controlled end, comprising:
the control centre sending security authentication request information to the wireless remote control end;
the wireless remote control end obtaining authentication operation behaviour data based on the authentication request information and sending the same to the control centre;
the control centre parsing the authentication operation behaviour data;
judging whether information about the parsed data matches a control instruction comparison table preset by the control centre; if so, proceeding to the step of issuing a corresponding control instruction to the current remotely controlled end.

4. The control method for a wireless remote control of claim 3, characterized in that the preset control instruction comparison table comprises:
building a control instruction comparison table of a one-to-one match between the connection operation behaviour data and the remotely controlled end; a control instruction comparison table of a one-to-one match between the target operation behaviour data and the remotely controlled end; and a control instruction comparison table of a one-to-one match between the authentication operation behaviour data and the remotely controlled end.

5. The control method for a wireless remote control of claim 4, characterized in that the connection operation behaviour data, target operation behaviour data and authentication operation behaviour data are touch operation behaviour data applied to the wireless remote control end or gesture operation behaviour data applied to the wireless remote control end respectively.

6. The control method for a wireless remote control of claim 5, characterized by judging whether information about the parsed data matches a control instruction comparison table preset by the control centre, comprising:
selecting single feature data or a plurality of feature data in the data information as a comparison criterion;
judging whether the comparison criterion falls into the threshold scope set in the control instruction comparison table; if so, indicating a successful match, proceeding to the next step.

7. The control method for a wireless remote control of claim 6, characterized in that feature data of the data information comprises spatial track data, speed, acceleration, time, distance between a starting point and an end point and/or angle of an operation behavior.

8. The control method for a wireless remote control of claim 7, characterized in that the wireless remote control end encrypting the target operation behaviour data, connection operation behaviour data, and/or authentication operation behaviour data and sending the same to the control centre.

9. The control method for a wireless remote control of claim 1, characterized by after the step of judging whether information about the parsed data matches a control instruction comparison table preset by the control centre, comprising:
the control centre feeding back prompt information in the form of vibration, sound, or light to the wireless remote control end.

10. A control system for a wireless remote control, characterized by:
a wireless remote control end used to obtain operation behaviour data, establish a connection with a remotely controlled end through a control processing device, and select the remotely controlled end to be remotely controlled as a current remotely controlled end;
a control processing device receiving operation behaviour data from the wireless remote control end, parsing the same, and judging whether information about the parsed data matches a control instruction comparison table preset by the control processing device; if so, judging whether a control instruction receiving end is the current remotely controlled end; and if so, issuing a corresponding control instruction to the current remotely controlled end; otherwise, establishing a connection with the end to be remotely controlled;
a remotely controlled end receiving the control instruction and performing a corresponding operation based on the control instruction.
